(19) United States
(12) Patent Application Publication
(10) Pub. No.: US 2026/0311085 A1
(43) Pub. Date: Oct. 8, 2026

(54) TECHNIQUES FOR ENABLING AI TO ATTEND MEETINGS AND PROVIDE CONTEXTUAL INFORMATION

(71) Applicant: Sembly AI, Inc., New York, NY (US)

(72) Inventors: Gil MAKLEFF, New York, NY (US); Artem KOREN, Staten Island, NY (US); Oleksandr SLONSKYI, Varna (BG)

(73) Assignee: Sembly AI, Inc., New York, NY (US)

(21) Appl. No.: 19/170,840

(22) Filed: Apr. 4, 2025

(51) Int. Cl. G06Q 10/0631; G06Q 10/1093

(52) U.S. Cl. CPC G06Q 10/063118; G06Q 10/1093

(57) ABSTRACT

A system and method for generating refined, personalized insights from a synchronized communication session are presented. The method includes receiving an initial set of considerations, based on nominal information about a plurality of user entities in the session and session data, wherein a consideration is an aspect of session data that is pertinent to a user entity; generating relevant considerations, based on the initial set of considerations and historical session data, wherein a relevant consideration is a consideration that is sufficiently relevant to at least one user entity; generating a set of provisional insights, wherein a provisional insight is an actionable recommendation directed to one of the plurality of user entities; iteratively refining the set of provisional insights, based on critique points for each provisional insight, until the set of provisional insights are sufficiently refined, and suggesting at least one customized deliverable to a participant based on the refined insights.

### TECHNICAL FIELD

The present disclosure relates generally to Natural Language Processing (NLP) of synchronized communication sessions to provide insights.

### BACKGROUND

Artificial intelligence (AI) meeting notetakers are advanced software tools that automatically transcribe and summarize meeting discussions using natural language processing (NLP) and machine learning algorithms. They capture spoken dialogue, identify key points, and generate concise summaries, allowing user entities to focus on the conversation without the distraction of manual notetaking. These tools often integrate with video conferencing platforms and can offer additional features such as action item tracking, keyword extraction, and sentiment analysis to enhance meeting productivity and follow-up.

Despite their capabilities, AI meeting notetakers face challenges in suggesting useful insights to users. One significant problem is their limited understanding of context and nuance. While they can identify keywords and phrases, they may struggle to grasp the deeper meaning or relevance of certain points, leading to insights that are either too generic or miss critical subtleties. This can result in recommendations that do not fully address the specific needs or concerns of the meeting participants.

Another problem with AI meeting notetakers'ability to suggest useful insights is their limited capacity to refine suggestions using enriched context from previous meetings. These tools often operate in isolation, analyzing each meeting as a standalone event without effectively integrating historical data. This lack of continuity means they may miss patterns or recurring themes that could provide deeper insights. Consequently, their recommendations might lack the depth and relevance that could be achieved by understanding the broader context of ongoing discussions and decisions. This limitation can hinder the AI's ability to offer truly valuable and contextually enriched insights that build on past interactions and knowledge.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving an initial set of considerations, based on nominal information about a plurality of user entities in the session and session data, where a consideration is an aspect of session data that is pertinent to a user entity, and where session data is data that relates to a present synchronized communication session. The method may also include generating relevant considerations, based on the initial set of considerations and historical session data, where a relevant consideration is a consideration that is sufficiently relevant to at least one user entity of the plurality of user entities, and where historical session data is data about at least one synchronized communication session that precedes the present synchronized communication session. The method may furthermore include generating a set of provisional insights, where a provisional insight is an actionable recommendation directed to one of the plurality of user entities. The method may in addition include iteratively refining the set of provisional insights, based on critique points for each provisional insight, until the set of provisional insights are sufficiently refined, where a critique point is an objective recommendation for improvement of each provisional insight. The method may moreover include suggesting at least one deliverable to a participant, where a deliverable is an output produced as required for a project, and where the at least on deliverable is customized for a user entity based on the refined insights. Other embodiments of this aspect include corresponding computer systems, apparatus, and computer programs recorded on one or more computer storage devices, each configured to perform the actions of the methods.

Implementations may include one or more of the following features. The method where receiving an initial set of considerations further may include: receiving nominal information for each user entity; receiving session data; generating an initial-considerations prompt, through a prompt engine, for a Large Language Model (LLM) that is configured to, when executed by a generative AI system, generate an initial set of considerations; feeding the initial-considerations prompt to the LLM; and generating an initial set of considerations by the generative AI system. The method where nominal information about a plurality of user entities includes a domain of an organization associated with each user entity; a role associated with each user entity in each respective organization; and a session type. The method where session data includes metadata of the session and transcription of at least one multi-media file associated with the session. The method where generating relevant considerations further may include: receiving the initial set of considerations; receiving historical session data; generating a relevant-considerations prompt, through a prompt engine, for a Large Language Model (LLM) that is configured to, when executed by a generative AI system, generate relevant considerations; feeding the relevant-considerations prompt to the LLM; and generating a relevant consideration by the generative AI system. The method where generating a set of provisional insights further may include: receiving relevant considerations; receiving historical session data; generating a provisional-insights prompt, through a prompt engine, for a Large Language Model (LLM) that is configured to, when executed by a generative AI system, generate provisional insights; feeding the provisional-insights prompt to the LLM; and generating a set of provisional insights by the generative AI system. The method where iteratively refining the set of provisional insights further may include: receiving session data and nominal information; receiving the set of provisional insights; generating an insight-review prompt, through a prompt engine, for a Large Language Model (LLM) that is configured to, when executed by a generative AI system, generate critique points on the set of provisional insights; feeding the insight-review prompt to the LLM; generating critique points by the generative AI system; and iteratively refining the set of provisional insights based on critique points until the set of provisional insights is sufficiently refined. The method where a user is associated with a respective user entity as identified by a respective identification tag in the a transcription of a multi-media file of a session. The method where objective recommendation for improvement of a set of provisional insights is a recommendation to increase the customization of the set of insights for an associated user entity. The method further may include: generating provisional insights based on nominal information, relevant considerations, session data, and historical session data. Implementations of the described techniques may include hardware, a method or process, or a computer tangible medium.

In one general aspect, non-transitory computer-readable medium may include one or more instructions that, when executed by one or more processing circuitries of a device, cause the device to: receive an initial set of considerations, based on nominal information about a plurality of user entities in the a session and session data, where a consideration is an aspect of session data that is pertinent to a user entity, and where session data is data that relates to a present synchronized communication session; generate relevant considerations, based on the initial set of considerations and historical session data, where a relevant consideration is a consideration that is sufficiently relevant to at least one user entity of the plurality of user entities, and where historical session data is data about at least one synchronized communication session that precedes the present synchronized communication session; generate a set of provisional insights, where a provisional insight is an actionable recommendation directed to one of the plurality of user entities; iteratively refine the set of provisional insights, based on critique points for each provisional insight, until the set of provisional insights are sufficiently refined, where a critique point is an objective recommendation for improvement of each provisional insight; and suggest at least one deliverable to a participant, where a deliverable is an output produced as required for a project, and where the at least on deliverable is customized for a user entity based on the refined insights. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: receive an initial set of considerations, based on nominal information about a plurality of user entities in the a session and session data, where a consideration is an aspect of session data that is pertinent to a user entity, and where session data is data that relates to a present synchronized communication session. The system may in addition generate relevant considerations, based on the initial set of considerations and historical session data, where a relevant consideration is a consideration that is sufficiently relevant to at least one user entity of the plurality of user entities, and where historical session data is data about at least one synchronized communication session that precedes the present synchronized communication session. The system may moreover generate a set of provisional insights, where a provisional insight is an actionable recommendation directed to one of the plurality of user entities. The system may also iteratively refine the set of provisional insights, based on critique points for each provisional insight, until the set of provisional insights are sufficiently refined, where a critique point is an objective recommendation for improvement of each provisional insight. The system may furthermore suggest at least one deliverable to a participant, where a deliverable is an output produced as required for a project, and where the at least on deliverable is customized for a user entity based on the refined insights. Other embodiments of this aspect include corresponding computer systems, apparatus, and computer programs recorded on one or more computer storage devices, each configured to perform the actions of the methods.

Implementations may include one or more of the following features. The system where the memory contains further instructions that, when executed by the processing circuitry for receiving an initial set of considerations, further configure the system to: receive nominal information for each user entity; receive session data; generate an initial-considerations prompt, through a prompt engine, for a Large Language Model (LLM) that is configured to, when executed by a generative AI system, generate an initial set of considerations; feed the initial-considerations prompt to the LLM; and generate an initial set of considerations by the generative AI system. The system where nominal information about a plurality of user entities includes a domain of an organization associated with each user entity a role associated with each user entity in each respective organization, and a session type. The system where session data includes metadata of the session and transcription of at least one multi-media file associated with the session. The system where the memory contains further instructions that, when executed by the processing circuitry for generating relevant considerations, further configure the system to: receive the initial set of considerations; receive historical session data; generate a relevant-considerations prompt, through a prompt engine, for a Large Language Model (LLM) that is configured to, when executed by a generative AI system, generate relevant considerations; feed the relevant-considerations prompt to the LLM; and generate a relevant consideration by the generative AI system. The system where the memory contains further instructions that, when executed by the processing circuitry for generating a set of provisional insights, further configure the system to: receive relevant considerations; receive historical session data; generate a provisional-insights prompt, through a prompt engine, for a Large Language Model (LLM) that is configured to, when executed by a generative AI system, generate provisional insights; feed the provisional-insights prompt to the LLM; and generate a set of provisional insights by the generative AI system. The system where the memory contains further instructions that, when executed by the processing circuitry for iteratively refining the set of provisional insights, further configure the system to: receive session data and nominal information; receive the set of provisional insights; generate an insight-review prompt, through a prompt engine, for a Large Language Model (LLM) that is configured to, when executed by a generative AI system, generate critique points on the set of provisional insights; feed the insight-review prompt to the LLM; generate critique points by the generative AI system; and iteratively refine the set of provisional insights based on critique points until the set of provisional insights is sufficiently refined. The system where a user is associated with a respective user entity as identified by a respective identification tag in the a transcription of a multi-media file of a session. The system where objective recommendation for improvement of a set of provisional insights is a recommendation to increase the customization of the set of insights for an associated user entity. The system where the memory contains further instructions which when executed by the processing circuitry further configure the system to: generate provisional insights based on nominal information, relevant considerations, session data, and historical session data. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 illustrates an example diagram of system for agentic processing according to various disclosed embodiments herein

FIG. 3 illustrates an example flowchart showing a process for generating refined insights according to the disclosed embodiments.

FIG. 4 is an example flowchart that illustrates a process for generating session attributes.

FIG. 5 illustrates an example flowchart of a process for generating relevant considerations.

FIG. 6 illustrates an example flowchart of a process for generating a set of provisional insights.

FIG. 7 illustrates an example flowchart of a process for generating critique points for the provisional set of insights.

FIG. 8 is an example schematic diagram of a system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating refined insights of a synchronized communication session (hereinafter referred to synchronized communication session or session, merely for simplicity purposes), using machine learning in a multi-stage process. Provisional insights are refined through an iterative process using multiple stages of agentic large language model (LLM) processing in order to yield sufficiently refined, personalized (e.g., useful, concrete, etc.) insights for users. Provisional insights are generated first through an iterative process to generate relevant considerations based on session attributes, which are generated based on nominal information and session data.

The provisional insights are refined in later stages, which involves generating personalized insights that are based not only on nominal information about users but also on enriched context about their in-meeting roles and goals based on the current and historical session data and relevant considerations generated in earlier stages of the multi-stage approach. The use of multiple stages of machine learning to generate refined insights based on enriched context allows for more accurate (e.g., relevant, personalized) insights compared to traditional methods. The disclosed embodiments not only provide accurate insights to users, but also provides suggested deliverables customized for the users based on the relevant insights, saving users'time and resources.

Additionally, the disclosed embodiments allow for automating a subjective manual process. The human mind is not equipped to perform the disclosed embodiments in a reliable, objective way because the human mind cannot perform the process of generating refined insights using a multi-stage machine learning process as disclosed herein. The human mind is not equipped to perform the operations of machine learning models.

Further, the disclosed embodiments allow for a consistent, objective generation of refined insights because the process includes multiple iterations of generating new insights based on objectively determined critique points, using large language models (LLMs), until the level of refinement of the insights reaches a pre-determined threshold. The human mind is not equipped to consistently generate and deliver such results in an objective manner because the human mind applies subjective criteria that may vary over many repetitions, leading to inconsistent results, and may vary between different human operators.

Moreover, the human mind cannot practically perform the disclosed embodiments because a human operator cannot practically analyze and operate on, using paper and pencil, the copious amount of data for each of a large plurality of user entities as performed as part of the disclosed embodiments to generate refined insights. A human operator would impractically perform the disclosed embodiments such that the results would not be achieved at speeds required to operably generate refined insights as disclosed herein.

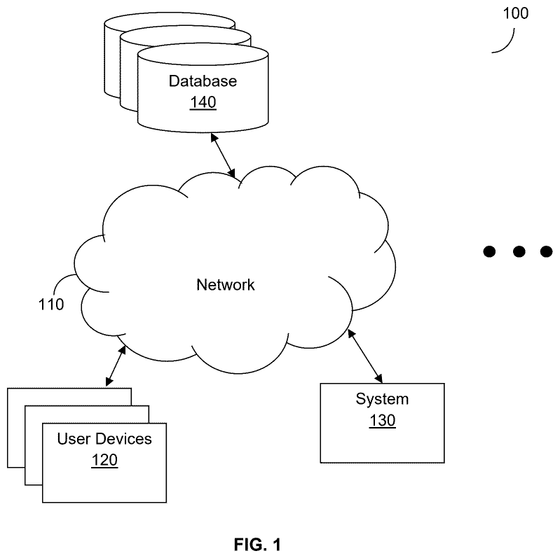

FIG. 1 shows an example network diagram 100 utilized to describe the various disclosed embodiments. In the example network diagram 100, user devices 120-1 through 120-N (hereinafter referred to individually as a user device 120 or collectively as user devices 120, merely for simplicity purposes), a system 130, and a plurality of databases 140-1 through 140-N (hereinafter referred to individually as a database 140 and collectively as databases 140, merely for simplicity purposes) communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The user devices 120 may be, but is not limited to, a personal computer, a laptop, a tablet computer, a smartphone, a wearable computing device, or any other device capable of receiving and displaying notifications. In an embodiment, the user devices 120 are devices that are used by individuals in an organization who communicate over the network 110 with each other via the user entity devices 120. In another embodiment, the user devices 120 are devices used by individuals not associated with an organization. In yet another embodiment, the user devices 120 used to communicate between individuals of different organizations. In other embodiments, the user devices 120 are used by a combination of such individuals.

In some embodiments, the database 140 stores nominal information (as defined hereinbelow), session data (as defined hereinbelow) and historical session data (as defined below). In some embodiments, the user devices 120 communicate the nominal information over the network 110 to the database 140. In other embodiments, the user devices 120 communicate the nominal information directly to the system 130 over the network 110.

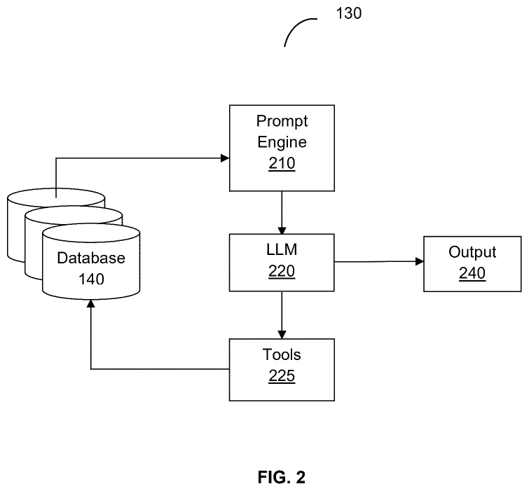

In some embodiments, the system 130 communicates with the database 140 over the network 110 as explained with respect to FIG. 2. The system 130 retrieves relevant information from the database 140 according to various disclosed embodiments.

The system 130 sends an output 240 (explained in detail hereinbelow) to the user devices 120 according to the various disclosed embodiments. The operation of the system 130 is discussed in more detail in FIG. 2 below.

FIG. 2 illustrates an example diagram of system 130 for agentic processing according to various disclosed embodiments herein. In an embodiment, the system 130 includes a prompt engine 210, an LLM 220, tools 225, database 140, and an output 240.

The prompt engine 210 is configured to generate a prompt for various tasks according to the various disclosed embodiments. In an embodiment, the prompt engine 210 includes a pre-configured template. In an embodiment, the template is manually pre-configured before the startup. The prompt engine 210 receives various inputs depending on the various embodiments disclosed hereinbelow. The prompt engine 210 then allocates the inputs, based on objective criteria, into appropriate placeholders in the pre-configured template. In an embodiment, the pre-configured template includes placeholders for a description of a role for the LLM, a description of the task for the LLM (depending on the embodiment and stage of processing), guidelines for achieving this task, and tools 225 available to complete the task. The prompt engine 210 feeds the generated prompt to the LLM 220.

The LLM 220 is at least one language model or large language model (LLM) such as, but not limited to, such as Generative Pre-trained Transformer-3 (GPT-3), Generative Pre-trained Transformer-J (GPT-J), Generative Pre-trained Transformer-4 (GPT-4), Text-to-Text Transfer Transformer (T5), Bidirectional and Auto-Regressive Transformers (BART), Language Model for Dialogue Applications (LaMDA), Large Language Model Meta AI (LLaMA), and the like, and more. The tools 225 are invoked by the LLM 220. The tools 225 invoked by the LLM 220 are the ones that are stated in the prompt generated by the prompt engine 210. An example of a tool 225 may be a search engine. The LLM 220 may invoke the search engine tool to query the database 140 for more relevant information in order to yield an objectively acceptable output for the particular processing step. Other examples of tools 225 may include Application Programming Interfaces (APIs), Software Development Kits (SDKs), web-scraping tools, vector databases, Natural Language Processing (NLP) libraries.

The database 140 includes data from synchronized communication sessions both current and past. This includes session metadata and a transcription of a multi-media file associated with the session (hereinafter, “session transcription”) from all the relevant synchronized communication sessions. Session data, session metadata, and session transcription are defined below. In an embodiment, the database 140 may also include nominal information (defined below), considerations (defined below), and insights (defined below).

In an embodiment, the relevant information in the database 140 that was queried by the tools 225 is sent to the prompt engine 210 to update and re-configure the prompt template. The prompt engine 210 then feeds the newly generated prompt to the LLM 220. The process according to this embodiment is iterative. Once the LLM 220 has yielded a sufficiently refined output for a particular processing step, then the output 240 is generated. This iterative process is discussed below according to the various disclosed embodiments.

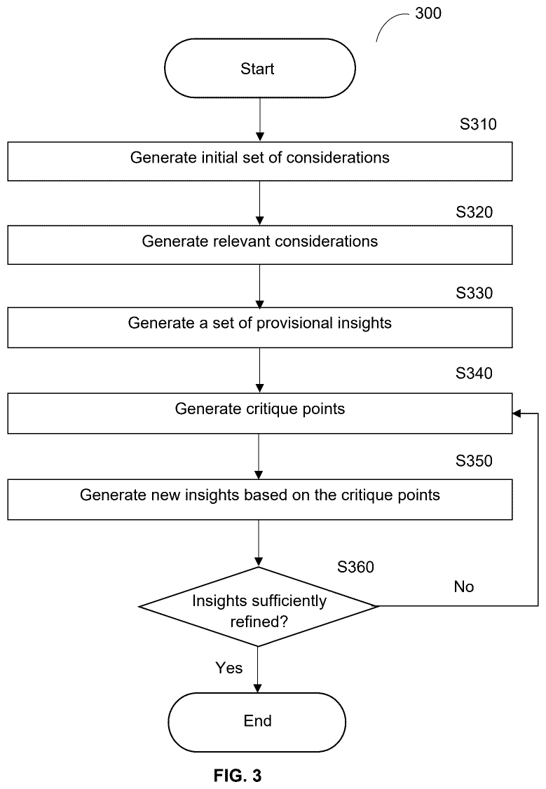

FIG. 3 illustrates an example flowchart 300 showing a process for generating refined, personalized insights according to the disclosed embodiments. The generation of an initial set of considerations, subsequent processing to yield relevant considerations, generation of provisional insights, and critique points on those provisional insights allow for refined insights that are suited to user entities. Further, the refined insights allow for the creation of suggested deliverables tailored to a user entity based on the refined insights. A deliverable is any tangible or intangible output produced as required for a project including, but not limited to, documents, emails, reports, software code, designs, or any other item that is created, developed, or provided to fulfill project requirements or objectives.

At S310, an initial set of considerations is received. A consideration is defined as an aspect of session data that is pertinent to a user entity. The initial set of considerations is based on nominal information. In some embodiments, nominal information is defined as information about a user entity in an organization which includes, but is not limited to, an organization domain, a user entity's role (e.g. title) in the organization, and a meeting type. A specific meeting type may be, for example, troubleshooting, project planning, board meeting, check-in, performance review, etc. Nominal information is received from a user entity through, for example, a user device 120.

Additionally, in an embodiment, web information is retrieved in real-time based on the nominal information. The retrieval of the web information is used to enrich the nominal information with up-to-date knowledge of the industry, organization, and the user entity's role. This enriched nominal information is used to produce the initial set of considerations.

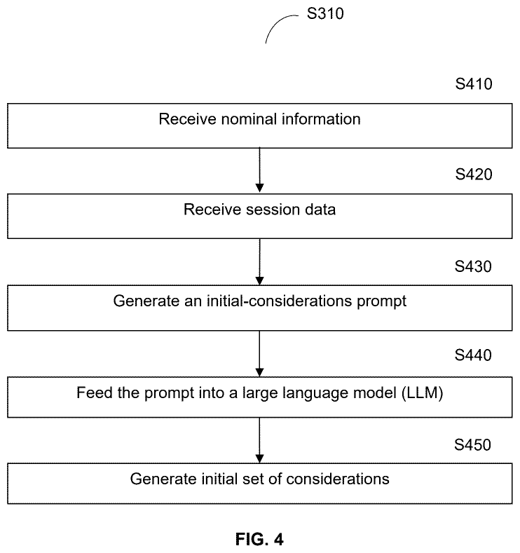

The disclosure describes the generation of an initial set of considerations in more detail in FIG. 4.

At S320, relevant considerations are generated. In some embodiments, relevant considerations are generated based on the initial set of considerations and session data.

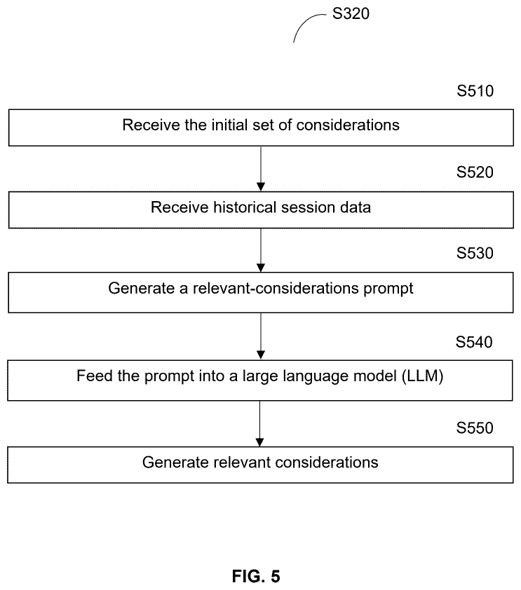

Session data is defined as data that relates to a particular synchronized communication session. Session data includes session transcription and session metadata. Session transcription is a written record of what was said in a synchronized communication session. Session metadata is the data that describes various details about a synchronized communication session. In one embodiment, this metadata includes, but is not limited to, the meeting title, data and time, duration, user entities and their assigned roles, location, shared materials, presented materials, or interactive elements e.g. hyperlinks. The generation of relevant considerations is described in more detail in FIG. 5.

At S330, a set of provisional insights is generated. An insight is defined as an actionable recommendation, directed to one or more user entities, contextualized from nominal information, session data, historical session data (defined as session transcriptions and session metadata from past synchronized communication sessions), and the relevant considerations. A provisional insight is defined as an insight that is not sufficiently refined. In some embodiments, an insight includes a deliverable as defined hereinabove.

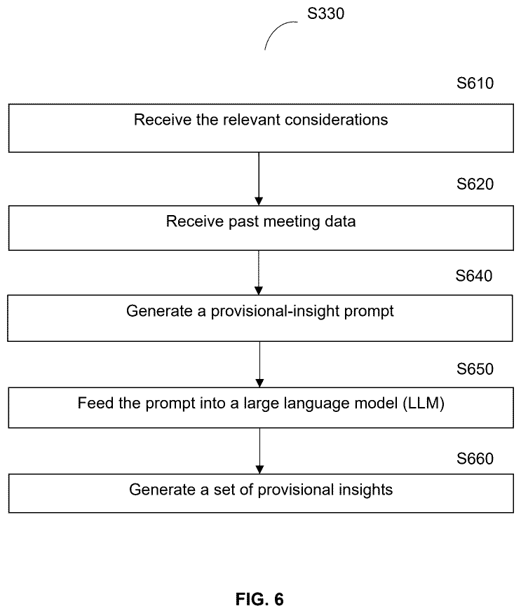

In an embodiment, the historical session data is used to provide an enriched context from which to generate the set of provisional insights. This process is described in more detail in FIG. 6.

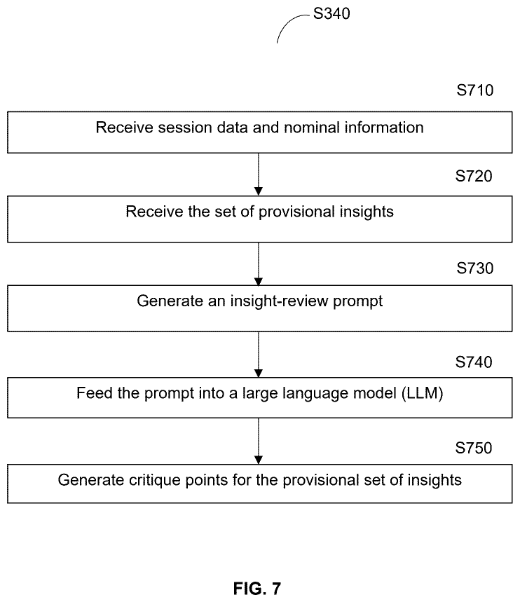

At S340, critique points are generated. A critique point is defined as an objective suggestion for an improved insight based on an objective evaluation of the set of provisional insights. In an embodiment, a critique point includes a name of the critique point and an explanation for the objective suggestion. This process is discussed in more detail in FIG. 7.

At S350, new insights are generated. In an embodiment, the new insights are generated based on the critique points e.g., based on the objective suggestions for improvement in the critique points. In some embodiments, the objective suggestions for improvements of the insights is determined based on, but not limited to, the degree of usefulness, relevance, or accuracy of the insights with respect to one or more user entities.

At S360, it is determined whether the new insights are sufficiently refined. In an embodiment, the level of refinement of the insights is based on a pre-determined threshold. In an embodiment, the pre-determined threshold may be set by the individual for whom the insight is generated, the organization to which the individual is a member, or a combination of both. In other embodiments, the pre-determined threshold may be changed dynamically.

In an embodiment, if the insights are sufficiently refined, execution ends. If the insights are not sufficiently refined, then execution returns with S340. In the embodiment in which execution returns with S340, critique points are generated based on the new insights. The process of iterative refinement of insights using critique points according to the disclosed embodiments ensures the relevance, usefulness, and accuracy of the insights for one or more user entities.

FIG. 4 is an example flowchart S310 that illustrates a process for generating an initial set of considerations.

At S410, nominal information is received. In an embodiment, this nominal information is received for each user entity and received from each user entity, organization, or other entity. This nominal information includes user entity's roles, organization domain, etc.

In an embodiment, web information is retrieved, as needed, in real-time based on the nominal information. The retrieval of the web information is used to enrich the nominal information with up-to-date knowledge of the industry, organization, and the user entity's role.

At S420, session data is received. The session data and nominal information are used to differentiate between a user entity's assigned role and their in-meeting role. Additionally, the session data and nominal information are used to differentiate between a user entity's or organization's nominal goal for a specific project and the goals that are detected based on the session data.

At S430, an initial-considerations prompt is generated. In one embodiment, the prompt is generated using a pre-configured template. In an embodiment, the prompt includes a description of a role for the LLM, a description of the task of the LLM (which is to generate a set of initial considerations), guidelines for achieving this task, and a list of tools available to complete the task. Additionally, inputs such as the session data and nominal information are placed in pertinent placeholders in the pre-configured template.

In one embodiment, the initial set of considerations is selected from a catalogue of considerations that are pre-mapped based on the nominal information and the session data. This pre-mapped catalogue is based on the session data and nominal information to tailor considerations for the particular industry, organization, and user entity.

At S430, the initial-considerations prompt is fed into at least one language model or large language model (LLM), such as, but not limited to, such as Generative Pre-trained Transformer-3 (GPT-3), Generative Pre-trained Transformer-J (GPT-J), Generative Pre-trained Transformer-4 (GPT-4), Text-to-Text Transfer Transformer (T5), Bidirectional and Auto-Regressive Transformers (BART), Language Model for Dialogue Applications (LaMDA), Large Language Model Meta AI (LLaMA), and the like, and more.

At S440, an initial set of considerations is generated. In an embodiment, the set of initial considerations are generated as the output of the initial-considerations prompt that is fed into the LLM. In an embodiment, the LLM calls tools (for example, tools 225) to achieve its task by, for example, retrieving historical session data.

FIG. 5 illustrates an example flowchart S320 of a process for generating relevant considerations.

At S510, an initial set of considerations are received. In an embodiment, the initial set of considerations are based on the session data and the nominal information as disclosed with respect to FIG. 3, S310. In another embodiment, the considerations are selected from a catalogue of considerations that are pre-mapped as explained above.

At S520, historical session data is received. Historical session data that is received is based on the initial set of considerations for a user entity for whom the relevant considerations are generated. This historical session data serves to enrich the relevant-considerations prompt at S530 so that the considerations that are generated are based on historical data for a user entity and are put in context of previous synchronized communication sessions, including the user entity's roles and goals over time.

At S530, a relevant-considerations prompt is generated. In one embodiment, the prompt is generated using a pre-configured template. In an embodiment, the prompt includes a description of a role for the LLM, a description of the task of the LLM (which is to generate relevant considerations), guidelines for achieving this task, and a list of tools available to complete the task. Additionally, inputs such as the initial set of considerations, and historical session data are placed in pertinent placeholders in the pre-configured template. The prompt template is configured to yield considerations that are relevant to one or more user entities.

At S540, the relevant-considerations prompt is fed into at least one language model or large language model (LLM), such as, but not limited to, such as Generative Pre-trained Transformer-3 (GPT-3), Generative Pre-trained Transformer-J (GPT-J), Generative Pre-trained Transformer-4 (GPT-4), Text-to-Text Transfer Transformer (T5), Bidirectional and Auto-Regressive Transformers (BART), Language Model for Dialogue Applications (LaMDA), Large Language Model Meta AI (LLaMA), and the like, and more.

At S550, a relevant consideration is generated. In an embodiment, the LLM, based on the relevant-considerations prompt, suggests new considerations that are sufficiently relevant to one or more user entities. In an embodiment, the LLM iteratively calls the tools it was prompted to use by the relevant-considerations prompt to achieve its task by, for example, retrieving more information from related synchronized communication sessions.

FIG. 6 illustrates an example flowchart S330 of a process for generating a set of provisional insights. As explained above, provisional insights are defined as provisional because they have not undergone the refinement process disclosed hereinafter with respect to FIGS. 3 and 7.

At S610, the relevant considerations are received. In an embodiment, the relevant considerations are generated as explained in FIG. 5.

At S620, historical session data is received. In an embodiment, historical session data includes session transcription from at least one past synchronized communication session and session metadata from at least one past synchronized communication session. In an embodiment, the historical session data is used to provide an enriched context that was not received in FIG. 5, S520 for the generation of the relevant considerations. This further-enriched context is used to generate the set of provisional insights.

At S640, a provisional-insights prompt is generated. In one embodiment, the prompt is generated using a pre-configured template. In an embodiment, the prompt includes a description of a role for the LLM, a description of the task of the LLM (which is to generate a set of provisional insights), guidelines for achieving this task, and a list of tools available to complete the task. Additionally, inputs such as the relevant considerations and historical session data are placed in pertinent placeholders in the pre-configured template.

In an embodiment, historical session data is placed in a pertinent placeholder in the pre-configured template such that the context of the input is enriched to yield the set of provisional insights.

At S650, the provisional-insight prompt is fed into at least one language model or large language model (LLM), such as, but not limited to, such as Generative Pre-trained Transformer-3 (GPT-3), Generative Pre-trained Transformer-J (GPT-J), Generative Pre-trained Transformer-4 (GPT-4), Text-to-Text Transfer Transformer (T5), Bidirectional and Auto-Regressive Transformers (BART), Language Model for Dialogue Applications (LaMDA), Large Language Model Meta AI (LLaMA), and the like, and more.

At S660, a set of provisional insights is generated. In an embodiment, the generation of the set of provisional insights involves the LLM iteratively invoking segments of the received historical session data that it deems relevant to the provisional insights based on the provisional-insight prompt.

FIG. 7 illustrates an example flowchart S340 of a process for generating critique points for the provisional set of insights. A critique point is, as defined above, an objective suggestion for an improved insight based on an objective evaluation of the set of provisional insights.

At S710, session data and nominal information are received. The session data and nominal information that is received is defined above.

At S720, the set of provisional insights is received. The set of provisional insights are received so that they are processed for review by the insight-review prompt as explained below.

At S730, an insight-review prompt is generated. In one embodiment, the prompt is generated using a pre-configured template. In an embodiment, the prompt includes a description of a role for the LLM (which is to generate critique points), a description of a task for the LLM (which is to generate critique points), guidelines for achieving this task, and a list of tools available to complete the task. Additionally, inputs such as the set of provisional insights, session data, and nominal information are placed in pertinent placeholders in the pre-configured template.

At S740, the insight-review prompt is fed into at least one language model or large language model (LLM), such as, but not limited to, such as Generative Pre-trained Transformer-3 (GPT-3), Generative Pre-trained Transformer-J (GPT-J), Generative Pre-trained Transformer-4 (GPT-4), Text-to-Text Transfer Transformer (T5), Bidirectional and Auto-Regressive Transformers (BART), Language Model for Dialogue Applications (LaMDA), Large Language Model Meta AI (LLaMA), and the like, and more.

At S750, critique points are generated. In an embodiment, a critique point includes a name of the critique point, an objective suggestion for the improvement of the set of provisional insights, and an explanation for the objective suggestion. In an embodiment, the critique points are used to refine the set of provisional insights are explained with respect to FIG. 3.

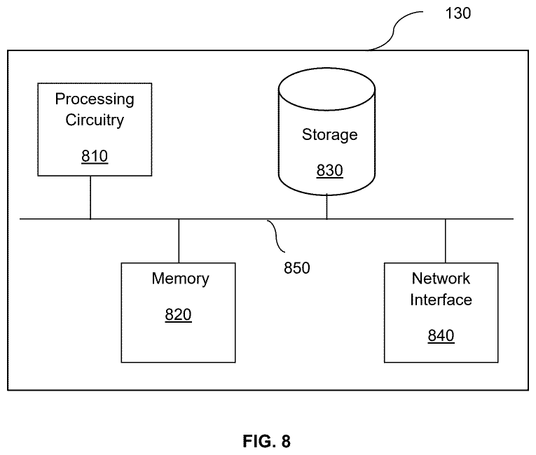

FIG. 8 is an example schematic diagram of a system 130 according to an embodiment. The system 130 includes a processing circuitry 810 coupled to a memory 820, a storage 830, and a network interface 840. In an embodiment, the components of the system 130 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

In at least some embodiments, the processing circuitry 810 is configured to execute generative artificial intelligence (genAI) models, perform inference using or otherwise apply genAI models, train genAI models, fine-tune genAI models, combinations thereof, and the like. Such genAI models are configured to produce text, images, videos, or other forms of data, and may include, but are not limited to, language models (for example, but not limited to, large language models, small language models, etc.), text-to-image artificial intelligence (AI) image generation systems, text-to-video AI video generators, combinations thereof, and the like. To this end, the processing circuitry 810 may be adapted to realize a transformer deep learning architecture (e.g., a generative pre-trained transformer [GPT], bidirectional encoder representations from transformers [BERT], text-to-text transfer transformer [T5], etc.), a diffusion model, both, and the like.

In accordance with various such embodiments, the hardware utilized for the processing circuitry 810 is selected in order to enable genAI functionality based on factors such as, but not limited to, parallelism (e.g., amounts of parallel processing to be performed), memory demands (e.g., amounts of random access memory [RAM] utilized to store model weights and training during processing or video RAM [VRAM] to support large language models), clock speeds, thread counts, storage (for example, to support certain amounts of storage or storage speeds), cooling (e.g., liquid cooling or air cooling systems), power supply (e.g., in order to enable a target wattage used for certain kinds of activities), networking and connectivity (e.g., in order to support seamless data transfer for deployments involving communications between or among multiple machines or clusters), combinations thereof, and the like.

In embodiments which utilize large language models (LLMs) or otherwise perform operations which may require or be enhanced through use of parallel processing, the processing circuitry 810 may include one or more GPUs or other processing units suitable for parallel processing. Such GPUs may be configured to perform matrix multiplication operations including, but not limited to, performing dot product operations in order to support neural network operations (for example, by performing dot product operations for hidden layer computations) or performing dot product operations in an attention mechanism in order to compute a similarity score between vectors during attention weight computation. In at least some such embodiments using GPUs, the processing circuitry 810 may include a number of CPU cores which is equal to or greater than the number of GPUs in order to facilitate or otherwise support parallel processing via multiple GPUs.

The memory 820 may be volatile (e.g., random access memory, etc.), non-volatile (e.g., read-only memory, flash memory, etc.), or a combination thereof.

In one configuration, software for implementing one or more embodiments disclosed herein may be stored in the storage 830. In another configuration, the memory 820 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 840 allows the system 130 to communicate with, for example, the user devices 120, the databases 140, and the like.

It should be understood that the embodiments described herein are not limited to the specific architecture illustrated in FIG. 8, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating refined, personalized insights from a synchronized communication session, comprising:
receiving an initial set of considerations, based on nominal information about a plurality of user entities in the session and session data, wherein a consideration is an aspect of session data that is pertinent to a user entity, and wherein session data is data that relates to a present synchronized communication session;
generating relevant considerations, based on the initial set of considerations and historical session data, wherein a relevant consideration is a consideration that is sufficiently relevant to at least one user entity of the plurality of user entities, and wherein historical session data is data about at least one synchronized communication session that precedes the present synchronized communication session;
generating a set of provisional insights, wherein a provisional insight is an actionable recommendation directed to one of the plurality of user entities;
iteratively refining the set of provisional insights, based on critique points for each provisional insight, until the set of provisional insights are sufficiently refined, wherein a critique point is an objective recommendation for improvement of each provisional insight; and
suggesting at least one deliverable to a participant, wherein a deliverable is an output produced as required for a project, and wherein the at least on deliverable is customized for a user entity based on the refined insights.

2. The method of claim 1, wherein receiving an initial set of considerations further comprises:
receiving nominal information for each user entity;
receiving session data;
generating an initial-considerations prompt, through a prompt engine, for a Large Language Model (LLM) that is configured to, when executed by a generative AI system, generate an initial set of considerations;
feeding the initial-considerations prompt to the LLM; and
generating an initial set of considerations by the generative AI system.

3. The method of claim 1, wherein nominal information about a plurality of user entities includes a domain of an organization associated with each user entity; a role associated with each user entity in each respective organization; and a session type.

4. The method of claim 1, wherein session data includes metadata of the session and transcription of at least one multi-media file associated with the session.

5. The method of claim 1, wherein generating relevant considerations further comprises:
receiving the initial set of considerations;
receiving historical session data;
generating a relevant-considerations prompt, through a prompt engine, for a Large Language Model (LLM) that is configured to, when executed by a generative AI system, generate relevant considerations;
feeding the relevant-considerations prompt to the LLM; and
generating a relevant consideration by the generative AI system.

6. The method of claim 1, wherein generating a set of provisional insights further comprises:
receiving relevant considerations;
receiving historical session data;
generating a provisional-insights prompt, through a prompt engine, for a Large Language Model (LLM) that is configured to, when executed by a generative AI system, generate provisional insights;
feeding the provisional-insights prompt to the LLM; and
generating a set of provisional insights by the generative AI system.

7. The method of claim 1, wherein iteratively refining the set of provisional insights further comprises:
receiving session data and nominal information;
receiving the set of provisional insights;
generating an insight-review prompt, through a prompt engine, for a Large Language Model (LLM) that is configured to, when executed by a generative AI system, generate critique points on the set of provisional insights;
feeding the insight-review prompt to the LLM;
generating critique points by the generative AI system; and
iteratively refining the set of provisional insights based on critique points until the set of provisional insights is sufficiently refined.

8. The method of claim 1, wherein a user is associated with a respective user entity as identified by a respective identification tag in a transcription of a multi-media file of a session.

9. The method of claim 1, wherein objective recommendation for improvement of a set of provisional insights is a recommendation to increase the customization of the set of insights for an associated user entity.

10. The method of claim 1, further comprises:
generating provisional insights based on nominal information, relevant considerations, session data, and historical session data.

11. A non-transitory computer-readable medium storing a set of instructions for generating refined, personalized insights from a synchronized communication session the set of instructions comprising:
one or more instructions that, when executed by one or more processing circuitries of a device, cause the device to:
receive an initial set of considerations, based on nominal information about a plurality of user entities in the session and session data, wherein a consideration is an aspect of session data that is pertinent to a user entity, and wherein session data is data that relates to a present synchronized communication session;
generate relevant considerations, based on the initial set of considerations and historical session data, wherein a relevant consideration is a consideration that is sufficiently relevant to at least one user entity of the plurality of user entities, and wherein historical session data is data about at least one synchronized communication session that precedes the present synchronized communication session;
generate a set of provisional insights, wherein a provisional insight is an actionable recommendation directed to one of the plurality of user entities;
iteratively refine the set of provisional insights, based on critique points for each provisional insight, until the set of provisional insights are sufficiently refined, wherein a critique point is an objective recommendation for improvement of each provisional insight; and
suggest at least one deliverable to a participant, wherein a deliverable is an output produced as required for a project, and wherein the at least on deliverable is customized for a user entity based on the refined insights.

12. A system for generating refined, personalized insights from a synchronized communication session comprising:
a processing circuitry;
a memory, the memory containing instructions that, when executed by the processing circuitry, configure the system to:
receive an initial set of considerations, based on nominal information about a plurality of user entities in the session and session data, wherein a consideration is an aspect of session data that is pertinent to a user entity, and wherein session data is data that relates to a present synchronized communication session;
generate relevant considerations, based on the initial set of considerations and historical session data, wherein a relevant consideration is a consideration that is sufficiently relevant to at least one user entity of the plurality of user entities, and wherein historical session data is data about at least one synchronized communication session that precedes the present synchronized communication session;
generate a set of provisional insights, wherein a provisional insight is an actionable recommendation directed to one of the plurality of user entities;
iteratively refine the set of provisional insights, based on critique points for each provisional insight, until the set of provisional insights are sufficiently refined, wherein a critique point is an objective recommendation for improvement of each provisional insight; and
suggest at least one deliverable to a participant, wherein a deliverable is an output produced as required for a project, and wherein the at least on deliverable is customized for a user entity based on the refined insights.

13. The system of claim 12, wherein the memory contains further instructions for receiving an initial set of considerations that, when executed by the processing circuitry, further configure the system to:
receive nominal information for each user entity;
receive session data;
generate an initial-considerations prompt, through a prompt engine, for a Large Language Model (LLM) that is configured to, when executed by a generative AI system, generate an initial set of considerations;
feed the initial-considerations prompt to the LLM; and
generate an initial set of considerations by the generative AI system.

14. The system of claim 12, wherein nominal information about a plurality of user entities includes a domain of an organization associated with each user entity a role associated with each user entity in each respective organization; and
a session type.

15. The system of claim 12, wherein session data includes metadata of the session and transcription of at least one multi-media file associated with the session.

16. The system of claim 12, wherein the memory contains further instructions for generating relevant considerations that, when executed by the processing circuitry, further configure the system to:
receive the initial set of considerations;
receive historical session data;
generate a relevant-considerations prompt, through a prompt engine, for a Large Language Model (LLM) that is configured to, when executed by a generative AI system, generate relevant considerations;
feed the relevant-considerations prompt to the LLM; and
generate a relevant consideration by the generative AI system.

17. The system of claim 12, wherein the memory contains further instructions for generating a set of provisional insights that, when executed by the processing circuitry, further configure the system to:
receive relevant considerations;
receive historical session data;
generate a provisional-insights prompt, through a prompt engine, for a Large Language Model (LLM) that is configured to, when executed by a generative AI system, generate provisional insights;
feed the provisional-insights prompt to the LLM; and
generate a set of provisional insights by the generative AI system.

18. The system of claim 12, wherein the memory contains further instructions for iteratively refining the set of provisional insights that, when executed by the processing circuitry, further configure the system to:
receive session data and nominal information;
receive the set of provisional insights;
generate an insight-review prompt, through a prompt engine, for a Large Language Model (LLM) that is configured to, when executed by a generative AI system, generate critique points on the set of provisional insights;
feed the insight-review prompt to the LLM;
generate critique points by the generative AI system; and
iteratively refine the set of provisional insights based on critique points until the set of provisional insights is sufficiently refined.

19. The system of claim 12, wherein a user is associated with a respective user entity as identified by a respective identification tag in a transcription of a multi-media file of a session.

20. The system of claim 12, wherein objective recommendation for improvement of a set of provisional insights is a recommendation to increase the customization of the set of insights for an associated user entity.

21. The system of claim 12, wherein the memory contains further instructions which when executed by the processing circuitry further configure the system to:
generate provisional insights based on nominal information, relevant considerations, session data, and historical session data.
